(19) United States
(12) Patent Application Publication
(10) Pub. No.: US 2018/0146030 A1
(43) Pub. Date: May 24, 2018

(54) SYSTEMS AND METHODS FOR LOAD BALANCING IN A CLOUD ENVIRONMENT

(71) Applicant: eBay Inc., San Jose, CA (US)

(72) Inventors: Dennis Weng, San Jose, CA (US); Dong Charles Li, Sunnyvale, CA (US)

(21) Appl. No.: 15/356,819

(22) Filed: Nov. 21, 2016

(51) Int. Cl. H04L 29/08; H04L 12/24; H04L 29/12

(52) U.S. Cl. CPC H04L 67/1002; H04L 41/0803; H04L 61/1511; H04L 69/329; H04L 69/326; H04L 69/327; H04L 69/328; H04L 69/325

(57) ABSTRACT

Methods, systems, and media for load balancing communication traffic in a publication system or cloud environment are disclosed. In one example, a load balancing system comprises a load balancer component configured to perform operations on a first portion of the communication traffic, and an elastic traffic manager component configured to perform operations on a second portion of the communication traffic. The first portion of the communication traffic may include Layer 3 communications as defined by an Open Systems Interconnection (OSI) model, and the second portion of the communication traffic includes at least one of Layer 4 through Layer 7 communications as defined by the OSI model.

### TECHNICAL FIELD

Embodiments of the present disclosure relate generally to data processing and, more particularly, but not by way of limitation, to systems and methods for load balancing of communication traffic in a cloud environment.

### BACKGROUND

“Cloud computing” generally refers to a computing environment with dynamically scalable and often virtualized resources, which are typically provided as services over the Internet. For example, cloud computing environments often employ the concept of virtualization as a convenient paradigm for hosting workloads on any appropriate hardware. The cloud computing model has become increasingly viable for many enterprises for various reasons, including that the cloud infrastructure may permit information technology resources to be treated as utilities that can be automatically provisioned on demand, while also limiting the cost of services to actual resource consumption. Moreover, consumers of resources provided in cloud computing environments can leverage technologies that might otherwise be unavailable. Thus, as cloud computing and cloud storage become more pervasive, many enterprises will find that moving data centers to cloud providers can yield economies of scale. But improving speed and scalability while reducing costs can present significant technical challenges in load balancing in cloud environments.

While much of the information technology industry moves toward cloud computing and virtualization environments, existing systems tend to fall short in adequately addressing concerns relating to managing or controlling workloads and storage in such environments. For example, cloud computing environments are generally designed to support generic business practices, meaning that individuals and organizations typically lack the ability to change many aspects of the platform, Moreover, concerns regarding performance, latency, reliability, and security present significant challenges, as outages and downtime can lead to lost business opportunities and decreased productivity, while the generic platform may present governance, risk, and compliance concerns. In other words, once organizations deploy workloads beyond the boundaries of their data centers, lack of visibility into the computing environment may result in significant management problems.

While these types of problems tend to be pervasive in cloud computing and virtualization environments due to the lack of transparency, existing systems for managing and controlling workloads that are physically deployed and/or locally deployed in home data centers tend to suffer from many similar problems. In particular, information technology has traditionally been managed in silos of automation, which are often disconnected from one another, For example, help desk systems typically involve a customer submitting a trouble ticket to a remedy system, with a human operator then using various tools to address the problem and close the ticket, while monitoring systems that watch the infrastructure to remediate problems may remain isolated from the interaction between the customer and the help desk despite such interaction being relevant to the monitoring system's function.

As such, because existing systems for managing infrastructure workloads operate within distinct silos that typically do not communicate with one another, context that has been exchanged between two entities can often be lost when the workload moves to the next step in the chain. When issues surrounding workload management are considered in the context of business objectives, wherein information technology processes and business issues collectively drive transitions from one silo to another, modern business tends to move at a speed that outpaces information technology's ability to serve business needs. Although emerging trends in virtualization, cloud computing, appliances, and other models for delivering services have the potential to allow information technology to catch up with the speed of business, many businesses lack the knowledge needed to intelligently implement these new technologies.

For example, emerging service delivery models often lead to deployed services being composed and aggregated in new and unexpected ways. In particular, rather than systems being designed and modeled from the ground up, new functionality is often generated on the fly with complex building blocks that tend to include various services and applications that have traditionally been isolated and standalone. As such, even though many emerging service delivery models provide administrators and users with a wider range of information technology choices than have ever before been available, the diversity in technology often compounds business problems and increases the demand for an agile infrastructure. Load balancers have also been deployed, but in architectures that do not lend themselves to efficient, or elastic, management of workload and traffic.

Thus, despite the promise that new service delivery models in the cloud can offer businesses, existing systems tend to fall short in providing information technology tools that can inform businesses on how to intelligently implement an information technology infrastructure in a manner that best leverages available technology to suit the particular needs of a business and balance workload and traffic.

### BRIEF DESCRIPTION OF TRE DRAWINGS

Some embodiments of the present disclosure are illustrated by way of example and not limitation in the figures of the accompanying drawings, in which like reference numbers indicate similar elements.

FIG. 1 is a block diagram illustrating a networked system, according to an example embodiment.

FIG. 2 is a block diagram showing architectural details of a publication system, according to some example embodiments.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 is a diagram illustrating a conventional load balancing architecture, in accordance with an example embodiment.

FIGS. 6-7 are diagrams illustrating load balancing architectures, in accordance with examples of the present inventive subject matter.

FIG. 8 is a flow chart depicting some operations in a load balancing method, in accordance with an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter can be practiced without these specific details. In general, well-known instruction instances, protocols, structures, and techniques have not been shown in detail. The present disclosure provides technical solutions for optimizing cloud deployment and for balancing load and traffic in a cloud environment. Systems, methods, and architectures for cloud deployment optimization are disclosed herein.

“CARRIER SIGNAL” in this context refers to any intangible medium that is capable of storing, encoding, or carrying instructions for execution by a machine, and includes digital or analog communications signals or other intangible media to facilitate communication of such instructions. Instructions may be transmitted or received over a network using a transmission medium via a network interface device and using any one of a number of well-known transfer protocols.

“CLIENT DEVICE” in this context refers to any machine that interfaces with a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronics system, game console, set-top box, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fit network, another type of network, or a combination of two or more such networks. For example, a network or a portion of a network may include a wireless or cellular network and the coupling of the client device to the network may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (IxRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“COMPONENT” in this context refers to a device, a physical entity, or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily^{,} configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“MACHINE-READABLE MEDIUM” in this context refers to a component, a device, or other tangible media able to store instructions and data temporarily or permanently, and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document contains material that is subject to copyright protection. The copyright owner has no objection to the facsimile reproduction by anyone of the patent document or the patent disclosure, as it appears in the Patent and Trademark Office patent tiles or records, but otherwise reserves all copyright rights whatsoever. The following notice applies to the software and data as described below and in the drawings that form a part of this document: Copyright 2016, eBay Inc., All Rights Reserved.

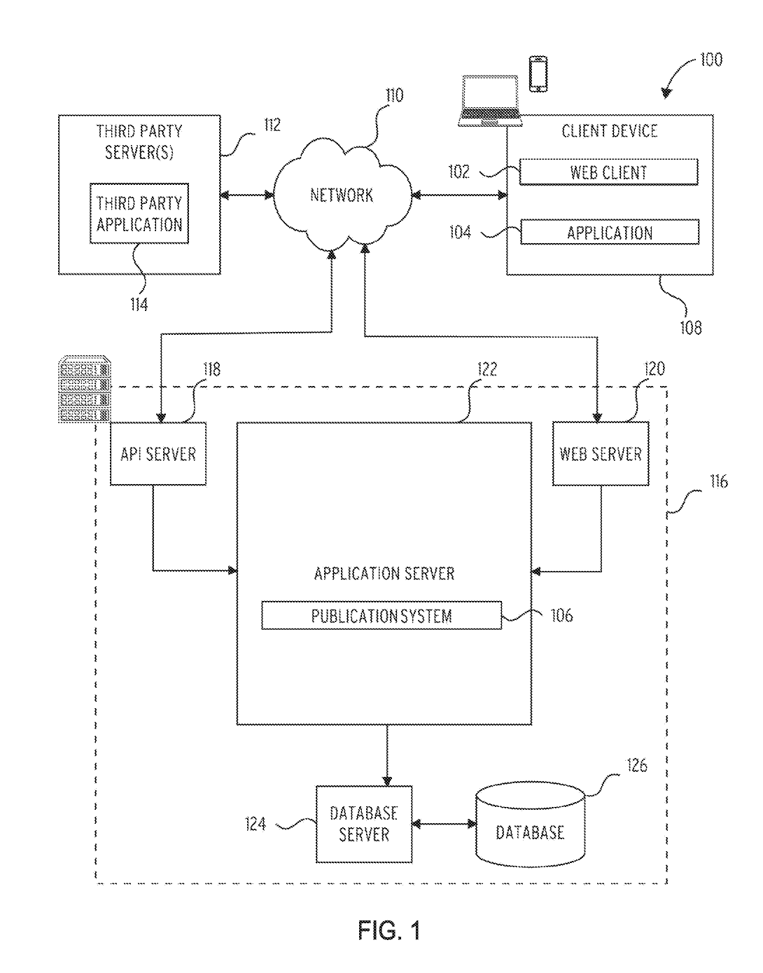

With reference to FIG. 1, an example embodiment of a high-level SaaS network architecture 100 is shown. A networked system 116 provides server-side functionality via a network 110 (e.g., the Internet or a WAN) to a client device 108. A web client 102 and a programmatic client, in the example form of an application 104, are hosted and execute on the client device 108. The networked system 116 includes an application server 122, which in turn hosts a publication system 106 that provides a number of functions and services to the application 104 that accesses the networked system 116. The application 104 also provides a number of interfaces described herein, which present output of tracking and analysis operations to a user of the client device 108.

The client device 108 enables a user to access and interact with the networked system 116. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An Application Program Interface (API) server 118 and a web server 120 are coupled, and provide programmatic and web interfaces respectively, to the application server 122. The application server 122 hosts a publication system 106, which includes components or applications. The application server 122 is, in turn, shown to be coupled to a database server 124 that facilitates access to information storage repositories (e.g., a database 126). In an example embodiment, the database 126 includes storage devices that store information accessed and generated by the publication system 106.

Additionally, a third-party application 114, executing on a third-party server(s) 112, is shown as having programmatic access to the networked system 116 via the programmatic interface provided by the API server 118. For example, the third-party application 114, using information retrieved from the networked system 116, may support one or more features or functions on a website hosted by a third party.

Turning now specifically to the applications hosted by the client device 108, the web client 102 may access the various systems (e.g., publication system 106) via the web interface supported by the web server 120. Similarly, the application 104 (e.g., an “app”) accesses the various services and functions provided by the publication system 106 via the programmatic interface provided by the API server 118. The application 104 may be, for example, an “app” executing on the client device 108, such as an IOS™ or ANDROID™ OS application to enable a user to access and input data on the networked system 116 in an offline manner, and to perform batch-mode communications between the application 104 and the networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The publication system 106 could also be implemented as a standalone software program, which does not necessarily have networking capabilities.

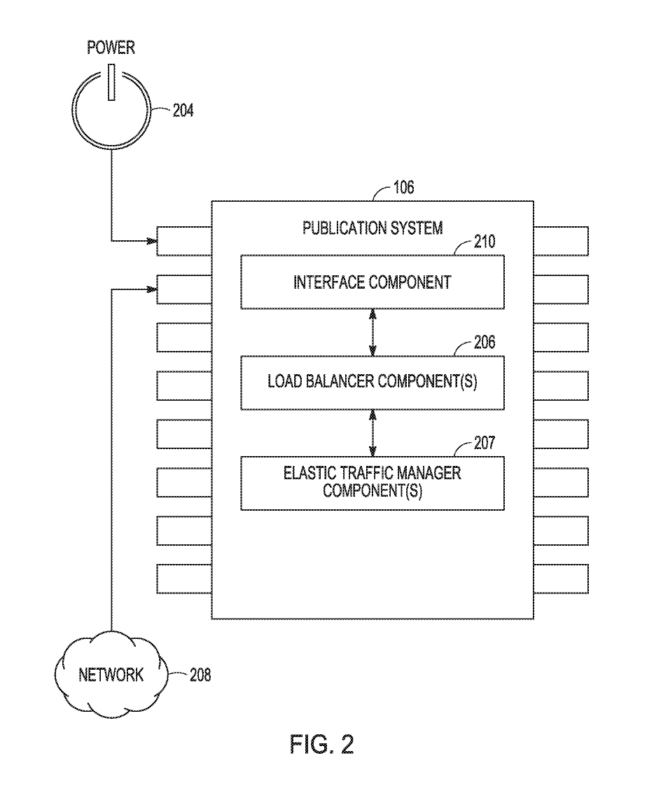

FIG. 2 is a block diagram showing architectural details of a publication system 106, according to some example embodiments. Specifically, the publication system 106 is shown to include an interface component 210 by which the publication system 106 communicates (e.g., over a network 208) with other systems within the SaaS network architecture 100.

The interface component 210 is collectively coupled to one or more load balancer components 206 that operate to balance load, in particular traffic load, in the publication system 106, in cooperation with one or more elastic traffic manager components 207, in accordance with the methods described further below with reference to the accompanying drawings.

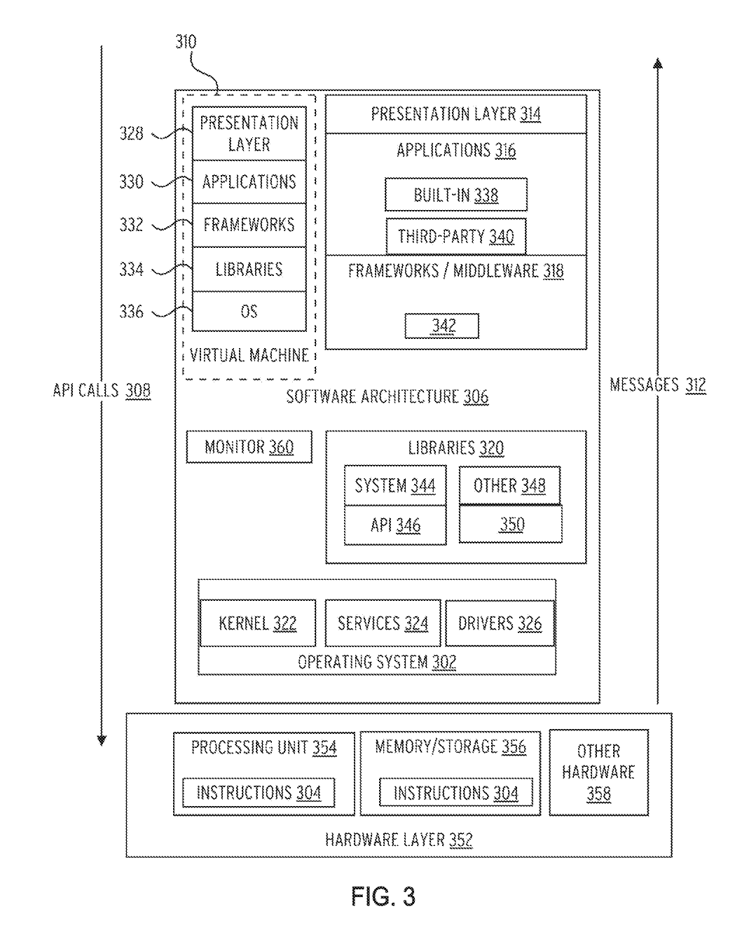

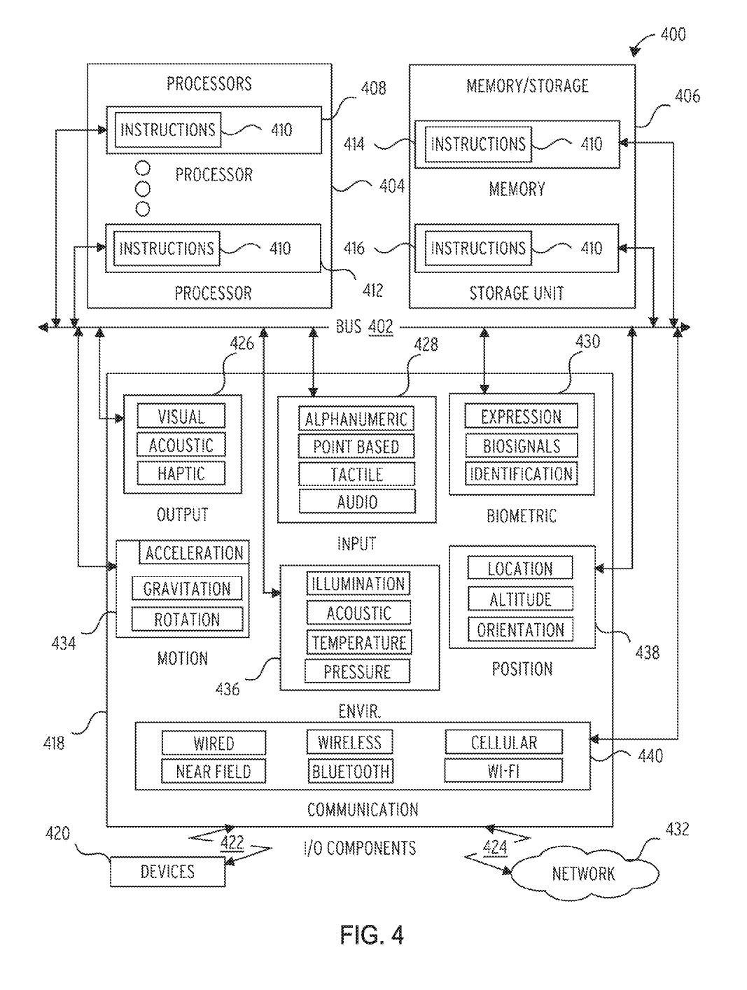

FIG. 3 is a block diagram illustrating an example software architecture 306, which may be used in conjunction with various hardware architectures herein described. FIG. 3 is a non-limiting example of a software architecture 306 and it will be appreciated that many other architectures may be implemented to facilitate the functionality described herein. The software architecture 306 may execute on hardware such as a machine 400 of FIG. 4 that includes, among other things, processors 404, memory/storage 406, and I/O components 418. A representative hardware layer 352 is illustrated and can represent, for example, the machine 400 of FIG. 4. The representative hardware layer 352 includes a processing unit 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke application programming interface (API) API calls 308 through the software stack and receive messages 312 in response to the API calls 308. The layers illustrated are representative in nature, and not all software architectures have all layers. For example, some mobile or special-purpose operating systems may not provide a frameworks/middleware: 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 (also sometimes referred to as middleware) provide a higher-level common infrastructure that may be used by the applications 316 and/or other software components/modules. For example, the frameworks/middleware 318 may provide various graphic user interface (GUI) functions, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. The third-party applications 340 may include any application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (operating system 302 in FIG. 3) and typically, although not always, has a virtual machine monitor 360, which manages the operation of the virtual machine 310 as well as the interface with the host operating system (i.e., operating system 302). A software architecture executes within the virtual machine 310, such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine into a particular machine programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404, memory/storage 406, and 110 components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific 1/0 components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion and the grouping is in no way limiting. In various example embodiments, the I/O components 418 may include output components 426 and input components 428. The output components 426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438 among a wide array of other components. For example, the biometric components 430 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies, The I/O components 418 may include communication components 440 operable to couple the machine 400 to a network 432 or devices 420 via a coupling 424 and a coupling 422 respectively. For example, the communication components 440 may include a network interface component or another suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geolocation, location via Wi-Fi® signal triangulation, location via detecting an NFC beacon signal that may indicate a particular location, and so forth.

Turning now to the publication system 106, communication traffic into or within that system can be defined according to the Open Systems Interconnection (OSI) model, for example as defined as of the date of this application at https://en.wikipedia.org/wiki/OSI. Extracts from this online publication appear below for ease of reference

The OSI model is a conceptual model that characterizes and standardizes the communication functions of a telecommunication or computing system, such as the publication system 106, without regard to their underlying internal structure and technology. Its goal is the interoperability of diverse communication systems with standard protocols. The model partitions a communication system into abstraction layers. The original version of the model defined seven layers.

A layer serves the layer above it and is served by the layer below it, example, a layer that provides error-free communications across a network provides the path needed by applications above it, while it calls the next lower layer to send and receive packets that comprise the contents of that path. Two instances at the same layer are visualized as connected by a horizontal connection in that layer. The model is a product of the Open Systems interconnection project at the international Organization for Standardization (ISO), maintained by the identification ISO/IEC 7498-1.

The OSI model proposes seven layers. There are three “media” layers (Layers 1 through 3), and four “host” layers (Layers 4 through 7). in general terms, data processing by two communicating OSI-compatible devices is done as follows. The data to be transmitted is composed at the topmost layer of the transmitting device (layer N) into a protocol data unit (PDU). The PDU is passed to layer N-1, where it is known as the service data unit (SDU). At layer N-1, the SDU is concatenated with a header, a footer, or both, producing a layer N-1 PDU. It is then passed to layer N-2. The process continues until reaching the lowermost layer, from which the data is transmitted to the receiving device. At the receiving device, the data is passed from the lowest to the highest layer as a series of SDUs while being successively stripped of each layer's header and/or footer, until reaching the topmost layer, where the last of the data is consumed.

More specifically, Layer 1 (the physical layer) defines the electrical and physical specifications of the data connection. It defines the relationship between a device and a physical transmission medium (e.g., a copper or fiber-optical cable, radio frequency). This includes the layout of pins, voltages, line impedance, cable specifications, signal timing, and similar characteristics for connected devices, and frequency (5 GHz, 2.4 GHz, etc.) for wireless devices. The physical layer is responsible for transmission and reception of unstructured raw data in a physical medium. It may define a transmission mode as simplex, half duplex, or full duplex. It defines the network topology, with bus, mesh, or ring being some of the most common. The physical layer of Parallel SCSI operates in this layer, as do the physical layers of Ethernet and other LANs, such as token ring, FDDI, ITU-T Cahn, and IEEE 802.11 (Wi-Fi), as well as personal area networks such as Bluetooth and IEEE 802.15.4. The physical layer is the layer of low-level networking equipment, such as some hubs, cabling, and repeaters. The physical layer is never concerned with protocols or other such higher-layer items. Examples of hardware in this layer are network adapters, repeaters, network hubs, modems, and fiber media converters.

Layer 2 (the data link layer) provides node-to-node data transfer a link between two directly connected nodes. It detects and possibly corrects errors that may occur in the physical layer. Among other things, it defines the protocol to establish and terminate a connection between two physically connected devices. It also defines the protocol for flow control between the devices. IEEE 802 divides the data link layer into two sublayers: a Media Access Control (MAC) layer, which is responsible for controlling how devices in a network gain access to a medium and permission to transmit over it; and a Logical Link Control (LLC) layer, which is responsible for identifying network layer protocols and then encapsulating them, and which controls error checking and frame synchronization.

The MAC and LLC layers of IEEE 802 networks, such as 802.3 Ethernet, 802.11 Wi-Fi, and 802.15.4 ZigBee, operate at the data link layer. The Point-to-Point Protocol (PPP) is a data link layer that can operate over several different physical layers, such as synchronous and asynchronous serial lines. The ITU-17 G.hn standard, which provides high-speed local area networking over existing wires (e.g., power lines, phone lines, and coaxial cables), includes a complete data link layer that provides both error correction and flow control by means of a selective-repeat sliding-window protocol.

Layer 3 (the network layer) provides the functional and procedural means of transferring variable-length data sequences (called datagrams) from one node to another connected to the same network. It translates logical network addresses into physical machine addresses. A network is a medium to which many nodes can be connected, on which every node has an address, and which permits nodes connected to it to transfer messages to other nodes connected to it by merely providing the content of a message and the address of the destination node and letting the network find the way to deliver the message to the destination node, possibly routing it through intermediate nodes. If the message is too large to be transmitted from one node to another on the data link layer between those nodes, the network may implement message delivery by splitting the message into several fragments at one node, sending the fragments independently, and reassembling the fragments at another node. It may, but need not, report delivery errors. Message delivery at the network layer is not necessarily guaranteed to be reliable; a network layer protocol may provide reliable message delivery, but it need not do so. A number of layer-management protocols, a function defined in the management annex, ISO 7498/4, belong to the network layer. These include routing protocols, multi cast group management protocols, network-layer information and error protocols, and network-layer address assignment protocols. It is the function of the payload that makes these belong to the network layer, not the protocol that carries them.

Layer 4 (the transport layer) provides the functional and procedural means of transferring variable-length data sequences from a source to a destination host via one or more networks, while maintaining the quality of service functions. An example of a transport-layer protocol in the standard Internet stack is the Transmission Control Protocol (TCP), usually built on top of the Internet Protocol (IP). The transport layer controls the reliability of a given link through flow control, segmentation/desegmentation, and error control. Some protocols are state- and connection-oriented. This means that the transport layer can keep track of the segments and retransmit those that fail. The transport layer also provides acknowledgement of successful data transmission and sends the next data if no errors occurred. The transport layer creates packets out of a message received from the application layer (Layer 7). Packetizing is a process of dividing the long message into smaller messages. OSI defines five classes of connection-mode transport protocols ranging from class 0 (which is also known as TP0 and provides the fewest features) to class 4 (TP4, designed for less reliable networks, similar to the Internet). Class 0 contains no error recovery, and was designed for use on network layers that provide error-free connections. Class 4 is closest to TCP, although TCP contains functions, such as the graceful close, which OSI assigns to the session layer. Also, all OSI TP connection-mode protocol classes provide expedited data and preservation of record boundaries. One way to visualize the transport layer is to compare it with a post office, which deals with the dispatch and classification of mail and parcels sent.

Layer 5 (the session layer) controls the dialogues (connections) among computers. It establishes, manages, and terminates the connections between local and remote applications. It provides for full-duplex, half-duplex, or simplex operation, and establishes checkpointing, adjournment, termination, and restart procedures. The OSI model made this layer responsible for graceful close of sessions, which is a property of TCP, and also for session checkpointing and recovery, which is not usually used in the IP suite. The session layer is commonly implemented explicitly in application environments that use remote procedure calls.

Layer 6 (the presentation layer) establishes context among application-layer entities, in which the application-layer entities may use different syntaxes and semantics if a presentation service provides a mapping among them. If a mapping is available, presentation service data units are encapsulated into session protocol data units, and passed down the protocol stack. This layer provides independence from data representation (e.g., encryption) by translating between application and network formats. The presentation layer transforms data into the form that the application accepts. This layer formats and encrypts data to be sent across a network. It is sometimes called the syntax layer.

Layer 7 (the application layer) is the OSI layer closest to the end user, which means that both the application layer and the user interact directly with the software application. This layer interacts with software applications that implement a communicating component. Such applications fall outside the scope of the OSI model. Application-layer functions typically include identifying communication partners, determining resource availability, and synchronizing communication. When identifying communication partners, the application layer determines the identity and availability of communication partners for an application with data to transmit. When determining resource availability, the application layer must decide whether sufficient network resources for the requested communication exist. In synchronizing communication, the application layer manages cooperation for all communication among applications. This layer supports application and end-user processes. Communication partners are identified, quality of service is identified, user authentication and privacy are considered, and any constraints on data syntax are identified. Everything at this layer is application-specific.

Conventionally, a load balancer (LB) in a cloud environment does most or all of the following tasks: a) distributes inbound traffic based on address (Layer 3 of the ISO/OSI model), b) routes outbound traffic, c) modifies port numbers (Layer 4 of the ISO/OSI model), d) handles SSL encryption and decryption (Layer 5 and layer 6 of the ISO/OSI model), and e) takes actions to the HTTP traffic (Layer 7 of ISO/OSI model). Performing all of these actions on one machine requires the machine to be complicated, highly available, and reliable. These attributes are expensive and hard to scale.

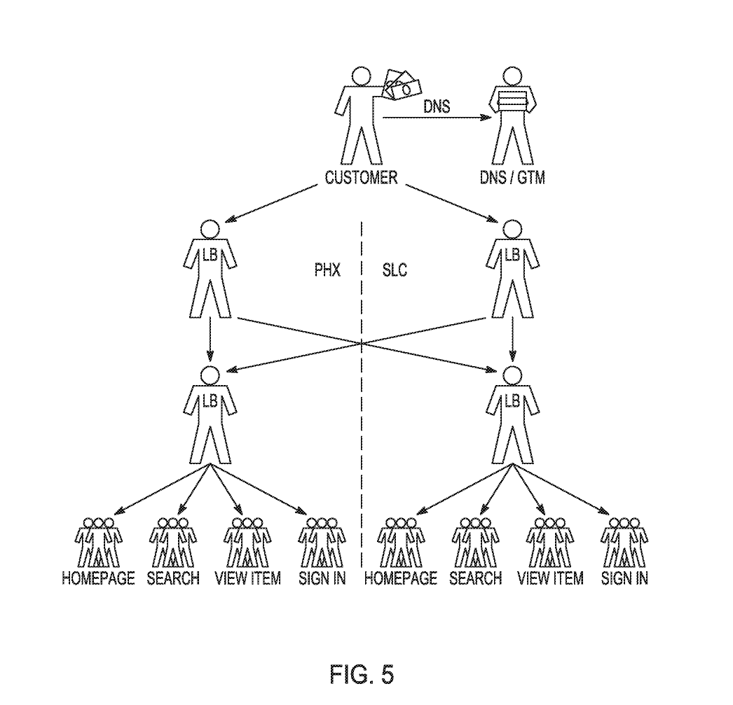

An example of a conventional load balancing architecture 500 is shown in FIG. 5. The load balancers, labeled LB, are of high cost and low agility. These drawbacks may not necessarily be a result of how the load balancers are implemented per se, but rather because the conventional load balancing architecture 500 places many, often heavy, operational requirements on to the load balancers. Conventionally, the operational requirements include handling all ingress load balancing of Layer 3 traffic, and in particular Layer 4 operations by using methods such as Network address translation (NAT). NAT is a method of remapping one IP address space into another by modifying network address information in Internet Protocol (IP) datagram packet headers while they are in transit across a traffic routing device. Conventional Layer 5 load balancing operations have included methods employing Secure Sockets Layer (SSL), also known as Transport Layer Security (TLS) but both frequently referred to as “SSL”. These methods are cryptographic protocols that provide communications security over a computer network, Conventional Layer 7 operations have included methods such as content switching, rewriting, and redirecting. All of the conventional methods can significantly inhibit high throughput, high service availability, and high performance.

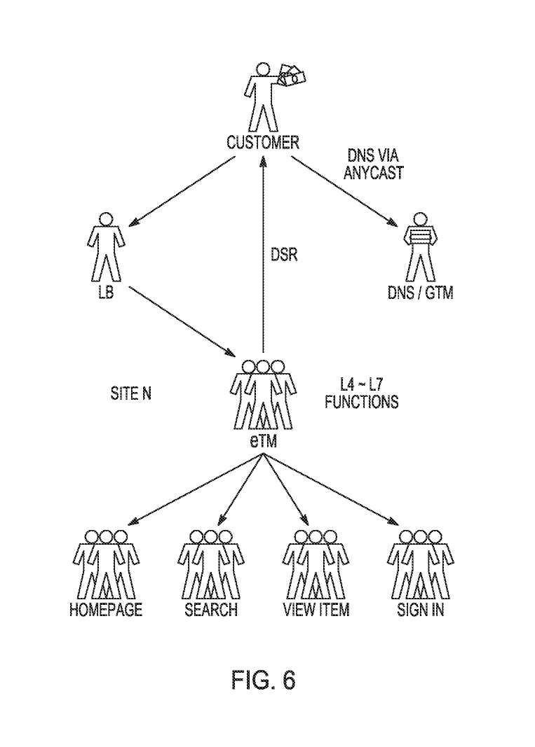

An alternate, improved load balancing architecture 600 of the present disclosure addresses these technical problems and is shown in FIG. 6. Here, the aforementioned load balancer is broken down into two components: a so-called Layer 3 (L3) load balancer (LB), such as the load balancer component 206 in FIG. 2, and an elastic traffic manager component (eTM), such as the elastic traffic manager component 207 shown in FIG. 2. The L3 load balancer performs Layer 3 ingress load balancing only, and the Layer 4 through Layer 7 load balancing functions are offloaded to a highly configurable and scalable eTM pool (for example, an eTM pool comprising the one or more elastic traffic manager components 207 of FIG. 2),

In a further example, egress traffic from the eTM pool to a user can be handled by Direct Server Return (DSR). A core design concept of load balancers can include distributing traffic load across multiple servers in order to increase reliability and performance while introducing the benefits of redundancy. By using DSR, incoming requests are assigned a Virtual IP address or VIP on the load balancer itself, and then the load balancer passes the request to the appropriate server with negligible modification to the packets. In non-DSR modes, the server responds to the load balancer with the required data and load balancer relays to the client. In DSR modes, the server to responds directly to the client, relieving the network load balancer of the need to handle heavy traffic load.

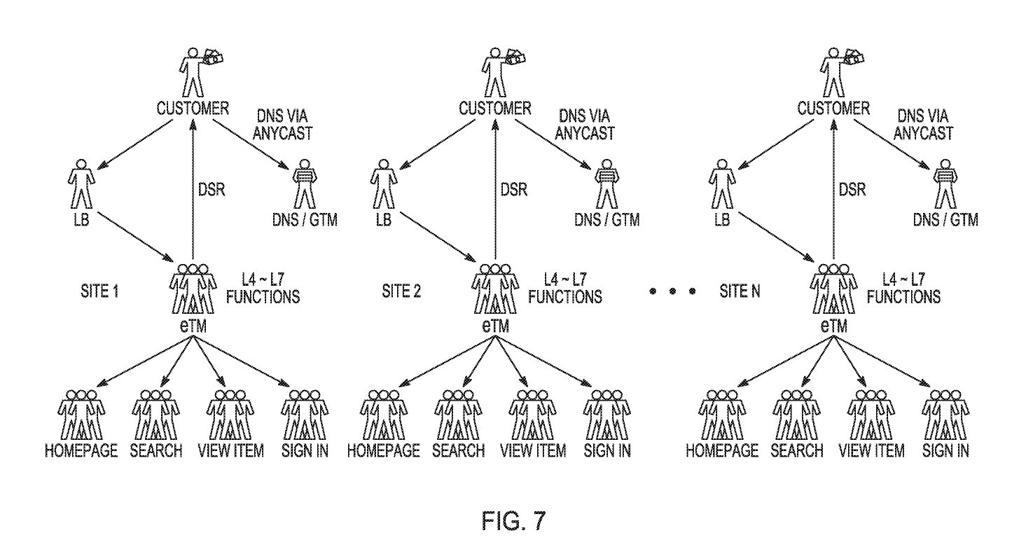

Domain Name Services (DNS) and Global Traffic Manager (GTM) operations can be handled by Anycast, a network addressing and routing methodology in which datagrams from a single sender are routed to the topologically nearest node in a group of potential receivers, though they may be sent to several nodes, all identified by the same destination address. A number of sites including this architecture can be deployed globally with communication traffic layers and operations (such as homepage, search, view-item, and sign-in) fully contained within each one, An extended example of this elastic architecture 700 is shown in FIG. 7. This architecture significantly improves traffic throughput, reduces cost, enhances efficient load balancing and high service availability, and boosts load balancing performance. GTM is also known as Global Server Load Balancing (GSLB) which is a mechanism to enable geographically distributed applications to scale and perform efficiently. Organizations that serve clients which are spread out geographically can distribute the applications) in multiple geographic locations, even around the globe.

Thus, in one aspect, the inventors split the factors of complexity and high availability into two different systems. A load balancer (e.g., load balancer component 206 in FIG. 2) performs task a above only, namely distributing the inbound traffic based on IP address. This operation typically needs to be highly available, but is not complicated, relatively speaking. Separately, an elastic (i.e., highly configurable and scalable) traffic manager (eTM), such as the elastic traffic manager component 207 (FIG. 2) performs tasks b to e described above. These further operations are relatively complicated but do not have to be provided in a highly available manner.

In one system embodiment, if any of the elastic traffic manager components 207 in FIG. 2 should fail, the load balancer component 206 detects this and takes the failing elastic traffic manager component 207 out of the system traffic automatically. In another embodiment, the elastic traffic manager component 207 continuously measures or defines the communication layers in operation. In some examples, the OSI model as defined above is used to determine what portions of the traffic communications layers are split out to the elastic side, for example splitting Layers 4 through 7 to the one or more elastic traffic manager components 207. This specific traffic splitting level is convenient because it delivers high performance, availability, and scalability at minimal cost. It has been found that splitting traffic at other levels (or not splitting the traffic at all) typically does not produce the same or similar results.

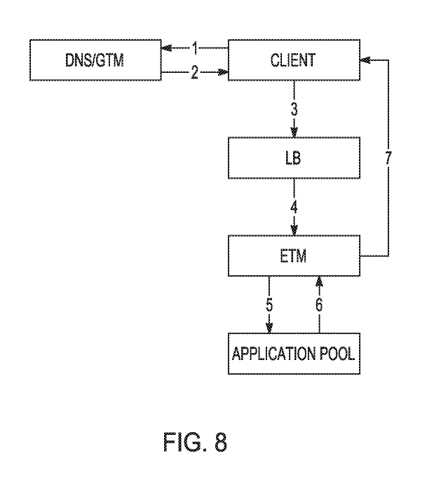

In further aspects of the present disclosure, methods for load balancing in a cloud environment are provided. An example flow chart for one such method 800 is shown in FIG. 8. At operation 1, a client sends a request to resolve a name to an IP address, for example seeking the IP address of the sign-in of the publication system 106, such as signin.pubsys.com. At operation 2, the DNS or GTM returns the most appropriate IP address (e.g., 67.211.181.81) for that sign-in to the client. At operation 3, the client sends a request to the IP address of the load balancer (e.g., 67.211.181.81). The load balancer in this method may be one or more of the load balancer components 206 in FIG. 2, or as shown at LB in FIG. 6 or 7. At operation 4, the load balancer sends the request to an eTM, such as one of the elastic traffic manager components 207 in FIG. 2, or a pool of the same. At operation 5, the eTM performs the appropriate Layer 4 to Layer 7 operations based on its configuration, and sends the request to an application pool. At operation 6, the application pool sends a response back to the eTM. At operation 7, the eTM sends the response directly back to the client, bypassing the load balancer and thus relieving it of the Layer 4 to Layer 7 operations.

Thus, in some examples, there is provided a load balancing system for balancing communication traffic in a publication system or cloud environment, the load balancing system comprising a load balancer component configured to perform operations on a first portion of the communication traffic; and an elastic traffic manager component configured to perform operations on a second portion of the communication traffic. The first portion of the communication traffic may include Layer 3 communications as defined by an Open Systems Interconnection (OSI) model. The second portion of the communication traffic may include at least one of Layer 4 through Layer 7 communications as defined by the OSI model. Egress traffic from the elastic traffic manager component to a user in the publication system may be handled by or conforms to a Direct Server Return (DSR) protocol.

In some examples, the publication system or cloud environment may include or communicate with a Domain Name Service (DNS) server, and communications with the Domain Name Service (DNS) server may include a network addressing and routing methodology in which datagrams from a single user are routed to a topologically nearest node in a group of potential receivers all identified by a same destination address.

The load balancer component may be further configured to monitor traffic communications in the publication system or cloud environment, and in the event of a failure of the elastic traffic manager component withdraw the elastic traffic manager component from the second portion of the communication traffic.

The present disclosure also includes example methods. In one example, a method for load balancing communication traffic in a publication system or cloud environment comprises configuring a load balancer component to perform operations on a first portion of the communication traffic, and configuring an elastic traffic manager component to perform operations on a second portion of the communication traffic. The first portion of the communication traffic may include Layer 3 communications as defined by an Open Systems Interconnection (OSI) model. The second portion of the communication traffic may include at least one of Layer 4 through Layer 7 communications as defined by the OSI model. Egress traffic from the elastic traffic manager component to a user in the publication system may be handled by or conforms to a Direct Server Return (DSR) protocol.

In some method examples, the publication system or cloud environment may include or communicate with a Domain Name Service (DNS) server, and communications with the Domain Name Service (DNS) server may include a network addressing and routing methodology in which datagrams from a single user are routed to a topologically nearest node in a group of potential receivers all identified by a same destination address.

The method may include configuring the load balancer component to monitor traffic communications in the publication system or cloud environment, and in the event of a failure of the elastic traffic manager component withdraw the elastic traffic manager component from the second portion of the communication traffic.

In some examples, a non-transitory machine-readable medium includes instructions that, when read by a machine, cause the machine to perform operations comprising at least the non-limiting example operations summarized above.

Although the subject matter has been described with reference to some specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A load balancing system for balancing communication traffic in a publication system or cloud environment, the load balancing system comprising:
a load balancer component configured to perform operations on a first portion of the communication traffic; and
an elastic traffic manager component configured to perform operations on a second portion of the communication traffic.

2. The load balancing system of claim 1, wherein the first portion of the communication traffic includes Layer 3 communications as defined by an Open Systems Interconnection (OSI) model.

3. The load balancing system of claim 1, wherein the second portion of the communication traffic includes at least one of Layer 4 through Layer 7 communications as defined by an Open Systems Interconnection (OSI) model.

4. The load balancing system of claim 1, wherein egress traffic from the elastic traffic manager component to a user in the publication system is handled by or conforms to a Direct Server Return (DSR) protocol.

5. The load balancing system of claim 1, wherein the publication system or cloud environment includes or communicates with a Domain Name Service (DNS) server, and wherein communications with the Domain Name Service (DNS) server include a network addressing and routing methodology in which datagrams from a single user are routed to a topologically nearest node in a group of potential receivers all identified by a same destination address.

6. The load balancing system of claim 1, wherein the load balancer component is further configured to monitor traffic communications in the publication system or cloud environment, and in the event of a failure of the elastic traffic manager component withdraw the elastic traffic manager component from the second portion of the communication traffic.

7. A method for load balancing communication traffic in a publication system or cloud environment, the method comprising:
configuring a load balancer component to perform operations on a first portion of the communication traffic; and
configuring an elastic traffic manager component to perform operations on a second portion of the communication traffic.

8. The method of claim 7, wherein the first portion of the communication traffic includes Layer 3 communications as defined by an Open Systems Interconnection (OSI) model.

9. The method of claim 7, wherein the second portion of the communication traffic includes at least one of Layer 4 through Layer 7 communications as defined by an Open Systems Interconnection (OSI) model.

10. The method of claim 7, further comprising handling or conforming egress traffic from the elastic traffic manager component to a user in the publication system by or to a Direct Server Return (DSR) protocol, respectively.

11. The method of claim 7, wherein the publication system or cloud environment includes or communicates with a Domain Name Service (DNS) server, and wherein communications with the Domain Name Service (DNS) server include a network addressing and routing methodology in which datagrams from a single user are routed to a topologically nearest node in a group of potential receivers all identified by a same destination address.

12. The method of claim 7, further comprising configuring the load balancer component to monitor traffic communications in the publication system or cloud environment, and in the event of a failure of the elastic traffic manager component withdraw the elastic traffic manager component from the second portion of the communication traffic.

13. A non-transitory machine-readable medium including instructions that, when read by a machine, cause the machine to perform operations comprising at least:
configuring a load balancer component to perform operations on a first portion of the communication traffic; and
configuring an elastic traffic manager component to perform operations on a second portion of the communication traffic.

14. The medium of claim 13, wherein the first portion of the communication traffic includes Layer 3 communications as defined by an Open Systems Interconnection (OSI) model.

15. The medium of claim 13, wherein the second portion of the communication traffic includes at least one of Layer 4 through Layer 7 communications as defined by an Open Systems Interconnection (OSI) model.

16. The medium of claim 13, wherein the operations further comprise handling or conforming egress traffic from the elastic traffic manager component to a user in the publication system by or to a Direct Server Return (DSR) protocol, respectively.

17. The medium of claim 13, wherein the publication system or cloud environment includes or communicates with a Domain Name Service (DNS) server, and wherein communications with the Domain Name Service (DNS) server include a network addressing and routing methodology in which datagrams from a single user are routed to a topologically nearest node in a group of potential receivers all identified by a same destination address.

18. The medium of claim 13. wherein the operations further comprise configuring the load balancer component to monitor traffic communications in the publication system or cloud environment, and in the event of a failure of the elastic traffic manager component withdraw the elastic traffic manager component from the second portion of the communication traffic.
